(19) United States
(12) Patent Application Publication
(10) Pub. No.: US 2009/0100383 A1
(43) Pub. Date: Apr. 16, 2009

(54) PREDICTIVE GESTURING IN GRAPHICAL USER INTERFACE

(75) Inventors: Derek Sunday, Renton, WA (US); Ali Vassigh, Bellevue, WA (US); Robert Levy, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/873,399

(22) Filed: Oct. 16, 2007

(51) Int. Cl. G06F 3/033

(52) U.S. Cl. 715/863

(57) ABSTRACT

A computing system. The computing system includes a display presenting a user interface, and a gesture input configured to translate a user gesture into a command for controlling the computing system. The computing system also includes a gesture-predicting engine to predict a plurality of possible commands based on the beginning of the user gesture, and a rendering engine to indicate the plurality of possible commands via the user interface.

### BACKGROUND

A variety of different user interfaces have been developed to allow humans to control machines. In the world of computers, various different graphical user interfaces are used in an attempt to make operating a computer more intuitive. One popular graphical user interface utilizes a desktop metaphor. The desktop metaphor uses a computer display as a virtual desktop upon which documents and folders of documents can be placed. Documents can take the form of text documents, photographs, movies, and various other content. A document can be opened into a window, which may represent a paper copy of the document placed on the virtual desktop.

While much work has been put into advancing the desktop metaphor, users continually seek easier ways to interact with digital content.

### SUMMARY

Predictive gesturing for use within a graphical user interface is provided. The predictive gesturing may be implemented on a variety of different computing platforms, including surface computing systems. Predictive gesturing facilitates the learning and execution of gestures that are used to control a graphical user interface. When a user begins to perform a gesture, a predictive-gesturing engine predicts which gestures the user may be attempting, and a rendering engine displays clues for completing the predicted gestures. As the user continues the gesture, the predictive-gesturing engine may progressively eliminate clues that are associated with predicted gestures from which the user gesture has diverged.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a surface computing system including a graphical user interface that is controllable by user gestures.

FIG. 2 shows a process flow diagram for predictive gesturing.

FIG. 3 continues the process flow diagram of FIG. 2 and shows a predictive gesturing scenario in which a user follows gesture path directions displayed by a rendering engine.

FIG. 4 continues the process flow diagram of FIG. 2 and shows a predictive gesturing scenario in which a user shortcuts a user gesture.

FIG. 5 shows a predictive gesturing scenario in which a user switches to a second gesture after beginning a first gesture.

### DETAILED DESCRIPTION

The present disclosure is directed to predictive gesturing in a graphical user interface that is at least partially controllable by user gestures. The following description provides a surface computing system as one possible example of a virtual workspace environment in which user gestures can be used to control a computing platform having a graphical user interface. However, other computing platforms can be used in accordance with the present disclosure. For example, while the below description refers to a user gesture in the form of a user finger interacting with the input surface of a surface computing system, a functionally analogous input may take the form of a computer mouse controlling a virtual pointer.

The predictive gesturing described below is considered to be applicable across a wide range of computing platforms and is not limited to surface computing systems. As such, the below description of a user gesture includes surface computing gestures without necessarily being restricted to only those gestures performed on a surface computing system. Predictive gesturing is also applicable to gestures made using mice, trackballs, trackpads, input pens, and other input devices for graphical user interfaces. Predictive gesturing may be implemented as a feature within a specific application or as a global feature of a computing device.

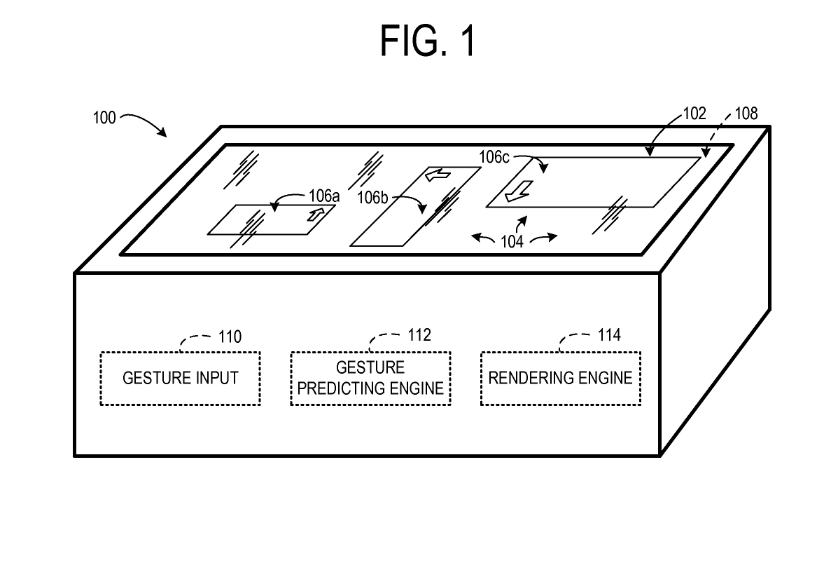

FIG. 1 shows a nonlimiting example of a surface computing system 100. Surface computing system 100 includes a display 102 for presenting a virtual workspace 104. A virtual workspace may include one or more virtual objects, such as digital photographs, calendars, clocks, maps, applications, documents, etc. Virtual workspace 104 includes virtual objects 106a, 106b, and 106c, which are schematically represented as rectangles.

Surface computing system 100 includes a gesture input 110 that is configured to translate a user gesture into a command for controlling the surface computing system. The gesture input may recognize the position of a user gesture relative to the display, and map the user gesture to a corresponding portion of the display. It may be said that the gesture input is operatively aligned with the display.

As used herein, the term gesture is used to refer to any user motion that can be detected by gesture input 110. Gestures can be performed in short or long movements, arbitrary or prescriptive movements, and straight-forth or non-intuitive movements. Gestures can be performed with a single contact, such as a finger, pen, hand, or any other input device. Gestures can also be performed with more than one contact, such as two fingers, two hands, etc. Nonlimiting examples of gestures include tracing an “S” shape over one or more virtual objects to execute a save command, circling one or more virtual objects to select the virtual objects, and dragging one or more virtual objects to move the virtual objects.

Various aspects of a gesture can be used to distinguish one gesture from another. One distinguishing aspect is the path of the gesture, which can be referred to as the gesture path. Other aspects that can be used to distinguish gestures are the distance the gesture covers and/or the speed with which the gesture is made.

The gesture input may recognize and track a user gesture via a touch sensitive surface, such as a capacitive and/or resistive touch screen. The gesture input may additionally or alternatively recognize and track a user gesture via an optical monitoring system that effectively views an input surface operatively aligned with the display to detect finger movement at or around the input surface. These or other input mechanisms can be used without departing from the scope of the present disclosure. As used herein, the term gesture input is used to refer to the actual surface with which a user interacts, as well as any complementary electronics or other devices that work to translate user gestures into commands that can be used to control the surface computing system.

Gesture input 110 allows a user to use a finger, or the like, to touch and manipulate interactive user interface elements and virtual objects in the virtual workspace of a surface computing system. A gesture input can enable users to avoid at least two interaction intermediaries that are present with other input mechanisms. First, the gesture input does not rely on an external device, such as a computer mouse, to control an on-screen cursor or pointer. Second, the use of on-screen scroll-bars or similar controls that manipulate other on-screen elements may be limited, if not avoided altogether. The gesture input may allow a user to directly touch and manipulate a virtual object, such as a list, without having to use a mouse, or other input device, to control an on-screen cursor, that in turn controls on-screen control elements, such as scroll-bars.

A surface computing system may be configured to recognize a large number of different gestures, each of which may correspond to a different command. Some of the gestures may be simple and intuitive, and thus, easy for a user to learn. Other gestures may be more complicated and/or less intuitive. Such gestures may be more difficult for a user to learn and/or remember.

As shown in FIG. 1, surface computing system 100 may include a gesture-predicting engine 112 and a rendering engine 114. The gesture-predicting engine and the rendering engine may cooperate to help a user learn and/or perform gestures. The gesture-predicting engine and the rendering engine are schematically represented in FIG. 1. As with the gesture input, the gesture-predicting engine and the rendering engine may each include one or more hardware, software, and/or firmware components that collectively perform the functions described herein.

The gesture-predicting engine analyzes user gestures that the gesture input receives. In particular, the gesture-predicting engine predicts which gestures a user may be attempting, or which gestures are possible, based on the beginning portion of a particular user gesture. The gesture-predicting engine predicts the possible commands that are associated with the gestures that could be completed from the beginning of the analyzed user gesture. As a user gesture continues, the gesture-predicting engine may progressively eliminate commands associated with gestures that do not match the analyzed user gesture.

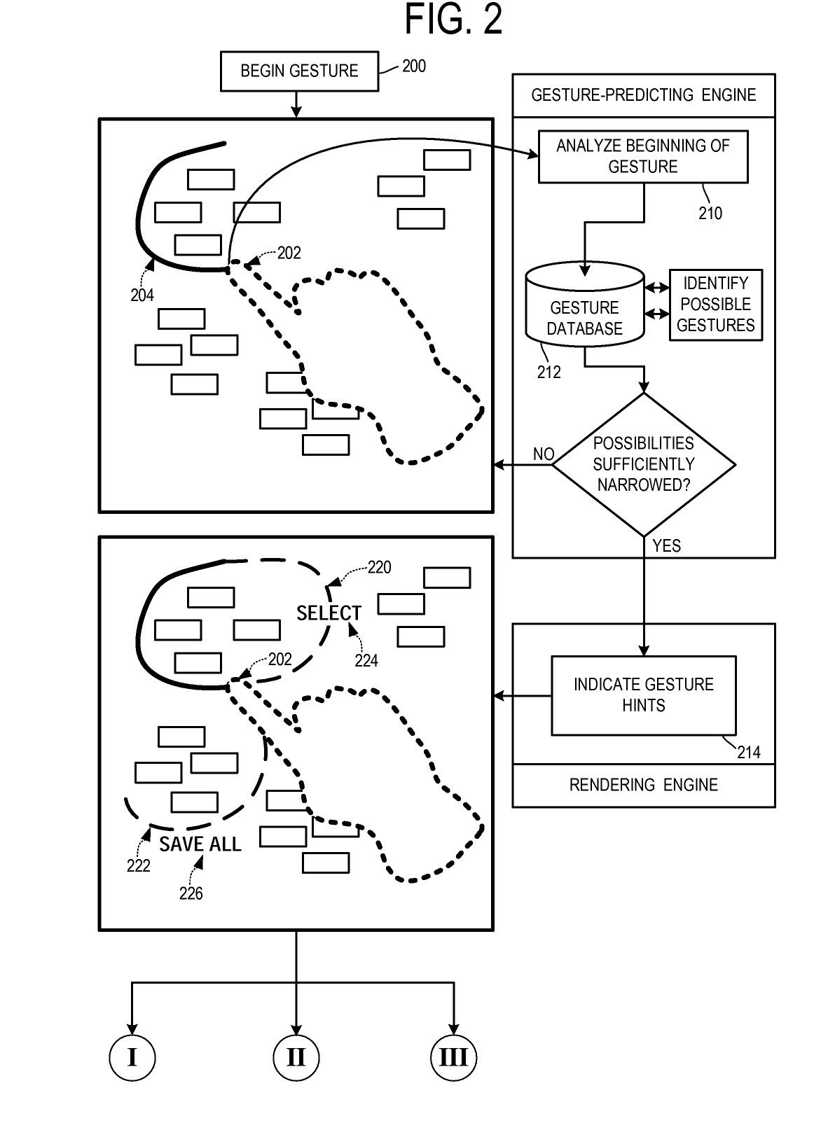

For example, FIG. 2 shows, at 200, beginning a gesture on a surface computing system. In the illustrated example, a finger 202 is beginning a gesture 204, which is represented as a thick line tracing the movement of the finger. As indicated at 210, a gesture-predicting engine analyzes the beginning of the gesture. Gesture analysis may include a comparison of the beginning of the user gesture to a plurality of different possible gestures catalogued in a gesture database 212. The gesture path, gesture speed, gesture distance, and other aspects of the gesture can be used to compare a user gesture to the catalogued gestures.

The catalogued gestures that have the same beginning, or at least a similar beginning, as the user gesture can be flagged as possibilities. As the user gesture is beginning, there may be a very large number of possibilities. As the user gesture continues and diverges from some of the possibilities, some possibilities may be eliminated.

As shown at 214, once the number of possible gestures has been sufficiently narrowed, the rendering engine may use the display to indicate the possible commands associated with the beginning of the analyzed gesture. The rendering engine may indicate the plurality of different possible commands at least in part by presenting, for each possible command, a hint for completing a user gesture associated with that possible command. The hint may include gesture path directions that show the user how to complete the gesture associated with a particular command. The hint may additionally or alternatively include a command shortcut that allows the user to perform a shortcut gesture in order to invoke the associated command.

Gesture path directions may include a virtual trail that a user can trace in order to complete a gesture. The virtual trail may be displayed in a manner that indicates that it is a path that may be followed. In the illustrated embodiment, gesture path directions 220 and 222 are represented as dashed lines. In some embodiments, a label that names the associated command may be associated with the gesture path directions. The label may include letters, numbers, symbols, icons, or other indicia for identifying the gesture and/or the command associated with the gesture. In some embodiments, such a label may serve as a command shortcut. In the illustrated embodiment, command shortcuts 224 and command shortcut 226 are represented as words naming the commands associated with the respective gestures.

A command shortcut may include a virtual button that may be pressed to invoke the associated command. The virtual button may take the form of a label that names the command associated with the gesture. The command shortcut provides a user with an opportunity to perform a shortened version of the gesture in order to invoke the associated command. For example, a user may begin a gesture along its gesture path and then shortcut the gesture by moving directly to the virtual button. A command shortcut may be placed at virtually any location within the virtual workspace. As nonlimiting example, the command shortcut may be placed near a user's finger, so as to provide the user with easy access to the command shortcut. As another example, the command shortcut may be placed along on or near the gesture path directions, so as to reinforce teaching of the gesture.

The example illustrated in FIG. 2 includes two hints for completing two different user gestures. Each gesture is associated with a different possible command. The first hint includes gesture path directions 222 and command shortcut 226 for invoking a “save all” command. The second hint includes gesture path directions 220 and command shortcut 224 for invoking a “select” command.

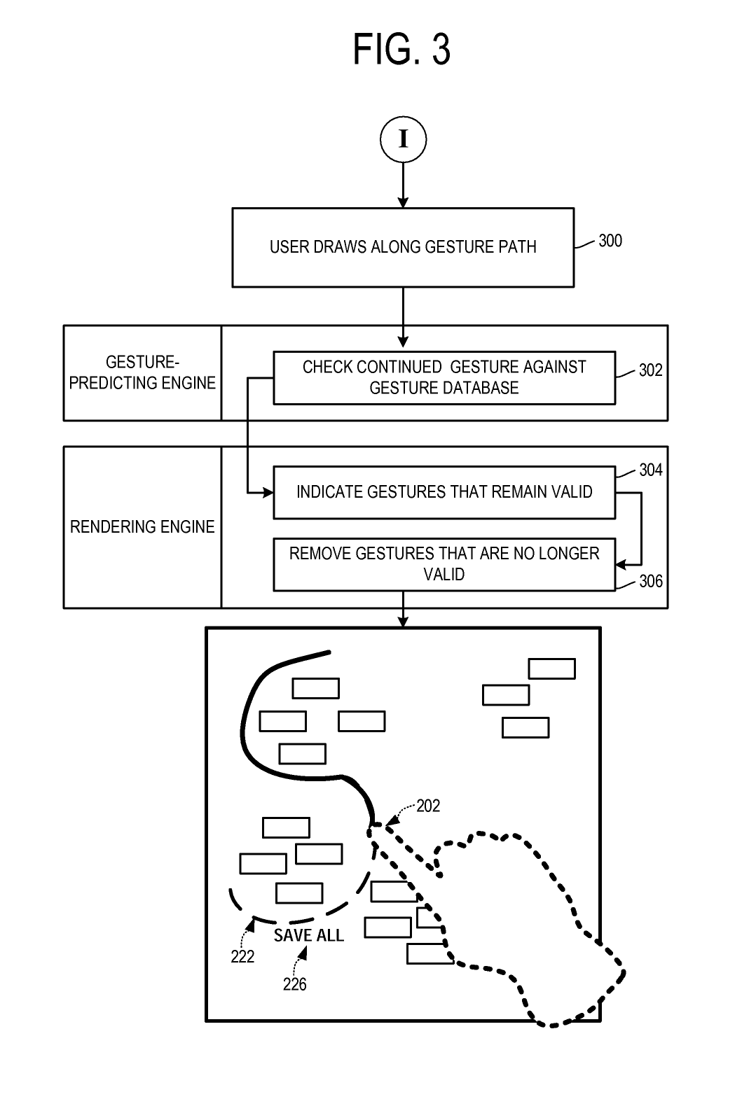

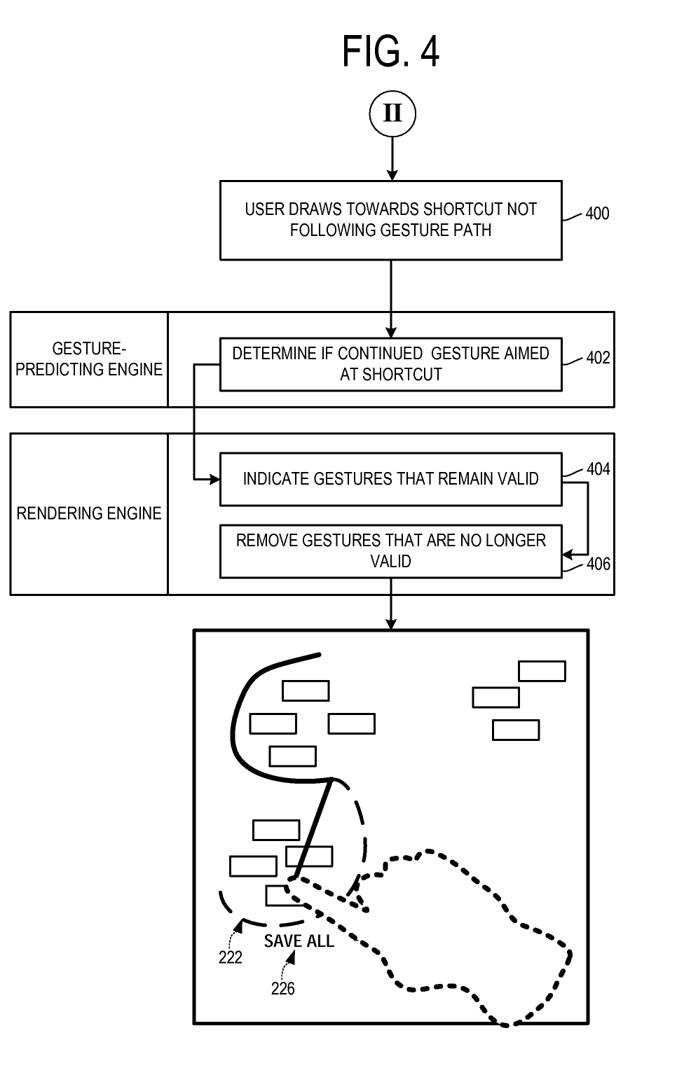

As illustrated in FIG. 3 and FIG. 4, as the user gesture continues, those commands associated with gestures that do not correspond to the continued gesture may be progressively eliminated. In other words, if the continued gesture no longer is on track to finish as a particular gesture, the gesture-predicting engine may remove that gesture and its associated command from the possible gestures that the user may be attempting to perform. Furthermore, the rendering engine may stop indicating commands that the gesture-predicting engine has progressively eliminated. In this way, the options available to a user may decrease as the user gesture continues.

FIG. 3 illustrates, at 300, an option where the user traces along the gesture path directions. In particular, finger 202 traces an S-shaped motion along gesture-path directions 222 associated with the “save all” command. At 302, the gesture-predicting engine checks the continued gesture against the gesture database. The gesture-predicting engine may optionally check the user gesture against a filtered subset of catalogued gestures within the gesture database to avoid checking gestures that have already been progressively eliminated. The gesture-predicting engine may identify catalogued gestures that remain consistent with the continued user gesture while eliminating cataloged gestures from which the user gesture has diverged.

At 304, the rendering engine indicates gestures that remain valid. At 306, the rendering engine removes gestures that are no longer valid. For example, as shown in FIG. 3, gesture path directions 222 and command shortcut 226 remain displayed, but gesture path directions 220 and command shortcut 224, which were associated with the “select” command, are removed. The eliminated possibilities may be removed in virtually any manner. For example, the gesture hints can be abruptly removed or gently faded from view. In some embodiments, hints associated with eliminated gestures may remain visible, but with an appearance that distinguishes them from gestures that remain valid.

FIG. 4 illustrates, at 400, an option where the user draws toward “save all” command shortcut 226 without following gesture path directions 222, which are associated with the “save all” command. At 402, the gesture-predicting engine determines if the user gesture is aimed toward a command shortcut. The gesture-predicting engine may identify command shortcuts to which the continued user gesture is aimed, while eliminating command shortcuts from which the user gesture has diverged.

At 404, the rendering engine indicates gestures that remain valid. At 406, the rendering engine removes gestures that are no longer valid. For example, as shown in FIG. 4, gesture path directions 222 and command shortcut 226 remain displayed, but gesture path directions 220 and command shortcut 224 are removed. A command shortcut may be selected by aiming the gesture toward the command shortcut. In some embodiments, the command shortcut may remain visible for a short time after a user lifts a finger from the gesture input surface or otherwise aborts the gesture, thus allowing the user to move the finger directly to the visible command shortcut without continuing the gesture. The command shortcut may alternatively be selected by using a different hand/finger to touch the command shortcut.

In some situations, a user gesture may continue along indicated gesture path directions while at the same time aiming toward a command shortcut associated with a different gesture. In such cases, the rendering engine may continue to present both options until the user gesture diverges.

As discussed above, once predicted gestures and/or associated command shortcuts are displayed, a user may select and follow one of the displayed gesture paths or aim toward one of the displayed command shortcuts. Responsive to this continued user gesture, other displayed gesture paths and/or command shortcuts may be eliminated as viable choices, and the eliminated choices may be hidden. The remaining gesture paths and command shortcuts may elaborate and progressively show more options if available or necessary. This form of progressive disclosure enables the user interface to remain uncluttered while presenting useful information and choices to the user.

In some embodiments, a computing system may be configured to automatically invoke a command associated with the last possible gesture remaining after all other gestures are progressively eliminated. In other words, if a single gesture is the only remaining option, the user can stop completing the gesture to invoke the associated command.

The predictive gesturing capability can optionally be a feature that a user can turn on or off. When on, predicted gestures may appear in several ways. For example, predictions may appear without delay as soon as the system has recognized and narrowed the possibilities to a reasonable number of choices for the user. Alternatively, the user may start a gesture, then pause long enough to signal to the system that help is needed, at which point the system may display the possible gestures.

The gesture-predicting engine may be configured to determine if a user has previously demonstrated aptitude with a gesture. For example, if the same user has successfully executed an S-shaped, “save all” gesture a number of times, the gesture-predicting engine may remove that gesture from the list of possible gestures that the user may need assistance completing. As such, if the user begins a gesture that is consistent with the S-shaped, “save all” gesture after the rendering-engine has recognized the user's proficiency with that gesture, the rendering engine may refrain from indicating hints associated with that gesture, thus focusing more attention on other hints.

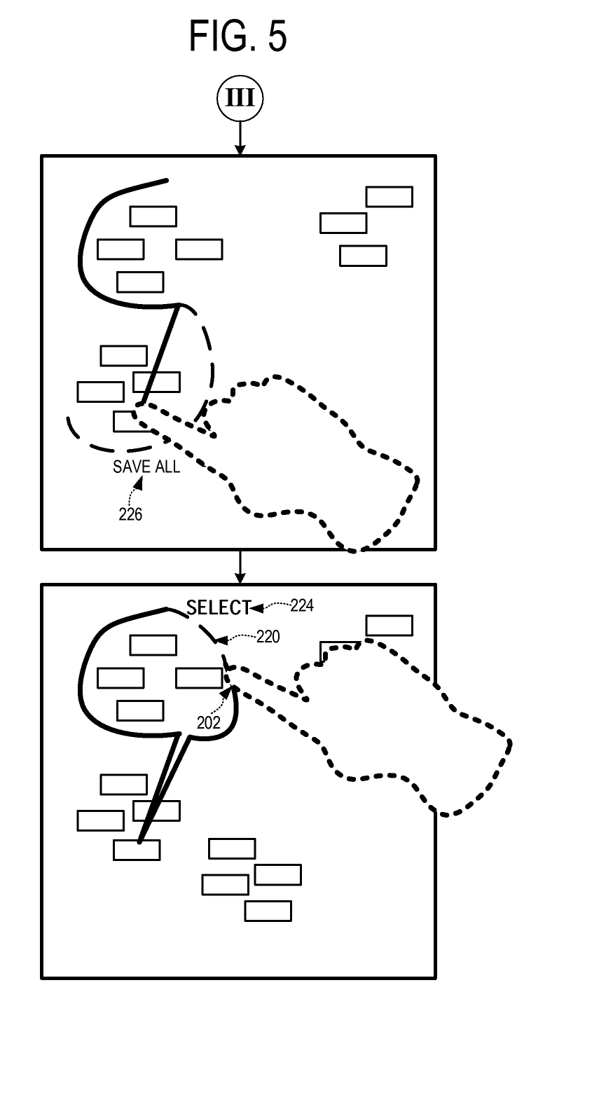

As shown in FIG. 5, the predictive-gesturing engine may recognize when a user changes her mind in the middle of completing a gesture. In particular, FIG. 5 shows finger 202 initially moving toward command shortcut 226 to invoke a “save all” command. The user then aborts the “save all” command by resuming a gesture that is consistent with the “select” command. The gesture-predicting engine may recognize the change, stop displaying the hints associated with the “save all” command, and once again display the hints associated with the “select command.”

In some embodiments, hints that have been removed may once again be displayed if a user pauses a gesture. Different and/or additional gestures may be displayed if the user continues to pause. In some embodiments, a computing device may have a mechanism for a user to proactively request additional hints and/or change the hints that are displayed, so that a user can find a hint that is associated with a command the user wishes to invoke.

Although the subject matter of the present disclosure has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A surface computing system, comprising:
a display presenting a user interface;
a gesture input operatively aligned with the display and configured to translate a user gesture into a command for controlling the surface computing system;
a gesture-predicting engine to predict a plurality of different possible commands based on a beginning of the user gesture; and
a rendering engine to indicate the plurality of different possible commands via the user interface.

2. The surface computing system of claim 1, where the gesture-predicting engine progressively eliminates possible commands from which the user gesture diverges.

3. The surface computing system of claim 2, where the rendering-engine stops indicating commands that the gesture-predicting engine has progressively eliminated.

4. The surface computing system of claim 1, where the rendering engine indicates the plurality of different possible commands at least in part by presenting, for each possible command, a hint for completing a user gesture associated with that possible command.

5. The surface computing system of claim 4, where presenting the hint includes presenting gesture path directions via the user interface.

6. The surface computing system of claim 4, where presenting the hint includes presenting a command shortcut via the user interface.

7. The surface computing system of claim 1, where the rendering engine indicates the plurality of different possible commands after a pause of the user gesture.

8. The surface computing system of claim 1, where the gesture-predicting engine is configured to determine that a user has not yet demonstrated aptitude with a gesture before a gesture hint for that gesture is displayed.

9. The surface computing system of claim 1, where the gesture input includes an input surface configured to recognize finger movement.

10. A computing system, comprising:
a display presenting a user interface;
a gesture input configured to translate a user gesture into a command for controlling the computing system;
a gesture-predicting engine to predict a plurality of possible commands based on a beginning of the user gesture; and
a rendering engine to indicate the plurality of possible commands via the user interface.

11. The computing system of claim 10, where the gesture-predicting engine progressively eliminates possible commands from which the user gesture diverges.

12. The computing system of claim 10, where the rendering engine indicates the plurality of different possible commands at least in part by presenting, for each possible command, a hint for completing a user gesture associated with that possible command.

13. The computing system of claim 12, where presenting the hint includes presenting gesture path directions via the user interface.

14. The computing system of claim 12, where presenting the hint includes presenting a command shortcut via the user interface.

15. A method of facilitating interaction with a user interface, comprising:
analyzing a beginning of a user input gesture;
identifying one or more possible gestures that begin with the beginning of the user input gesture; and
rendering, for each possible gesture; a gesture hint indicating how that gesture is completed.

16. The method of claim 15, further comprising analyzing the user input gesture as the user input gesture continues and progressively eliminating possible gestures from which the user input gesture diverges.

17. The method of claim 15, further comprising ceasing to render the gesture hint for each progressively eliminated possible gesture.

18. The method of claim 15, where rendering a gesture hint includes displaying gesture path directions.

19. The method of claim 15, where rendering a gesture hint includes displaying a command shortcut.

20. The method of claim 15, further comprising determining that a user has not yet demonstrated aptitude with a gesture before rendering a gesture hint for that gesture.
